(19) United States
(12) Patent Application Publication
(10) Pub. No.: US 2005/0185698 A1
(43) Pub. Date: Aug. 25, 2005

(54) Spread spectrum acquisition

(76) Inventor: David Harry Broughton, Nutfield (GB)

Correspondence Address: BARNES & THORNBURG, P.O. BOX 2786, CHICAGO, IL, 60690-2786, US

(21) Appl. No.: 11/036,474

(22) Filed: Jan. 14, 2005

(30) Foreign Application Priority Data
Jan. 16, 2004 (GB) GB 0400987.4

(51) Int. Cl. H04J 11/00

(52) U.S. Cl. 375/140; 370/209

(57) ABSTRACT

To receive a spread spectrum signal without access to the timing information of the transmitter, it is necessary to synchronise timing at the receiver. Assuming each symbol is represented by n chips, synchronisation is done using a search algorithm that receives n−1 chips and determines whether k1 of those chips match, repeating the procedure until they do. Since only n−1 chips are sampled, the method cycles through possible timings until the correct timing is found. After synchronisation, a variety of techniques are used to maintain synchronisation until the complete message has been retrieved, many of which techniques abort message receipt if fewer than various predetermined numbers of chips match possible symbols. The predetermined numbers k, k3, k4, k5 may vary for different parts of the message.

### FIELD OF INVENTION

The invention relates to a method for detecting and demodulating spread spectrum codes, especially direct sequence spread spectrum codes, to apparatus for carrying out the method and to a computer program for carrying out the method.

### BACKGROUND ART

Direct Sequence Spread Spectrum (DSSS) is a spread spectrum technique where a pseudo-random code directly phase modulates a carrier, and hence spreads its signal over a wide frequency band generating a noise-like signal. DSSS generates a redundant pattern for each symbol to be transmitted. This pattern is called a chipping code. The longer the chipping code, the greater the probability that the original data can be recovered, but the more bandwidth required. Even if one or more bits in the chipping sequence are damaged during transmission, statistical techniques embedded in the receiver can recover the original data without the need for retransmission.

To the receiver, DSSS appears as low-power wideband noise spectrum and is rejected, that is to say ignored, by narrowband receivers. The signal is despread (or converted from a received chipping sequence to individual symbols) by correlating with a pseudo-random code identical to and in synchronization with the code used to spread the carrier at the transmitter.

The problem is how to detect and demodulate DSSS codes from a received data stream where there is no timing synchronization between transmitter and receiver. The receiver needs somehow to recover the original timing information.

Current state of the art designs use correlation techniques such as matched filtering to despread the received signal. An article presently available on line at http://cas.et.ttudelft.n1/˜glas/thesis/node33.html describes one method of code synchronisation. However, such techniques are quite complicated and require considerable computing power.

In packet based message systems, each packet is generally preceded by a preamble and start of message synchronisation word. It is important to guarantee that symbol synchronisation is completed before the synchronisation word is received. In a packet based system it is important that false synchronisation is avoided since resynchronisation during a packet will cause the whole data packet to be lost. False synchronisation will cause noise to be received as data, and may cause the receiver to miss wanted signals while occupied receiving noise.

There is thus a need for fast and reliable synchronisation methods, as well as methods for tracking the received signal to retain synchronisation during receipt of a message.

### SUMMARY OF THE INVENTION

According to the invention there is provided a method of receiving a direct sequence spread spectrum signal message including a plurality of symbols each represented by n chip samples each lasting a chip sample period, wherein each of a number of possible transmitted symbols is represented by a corresponding set of n chip samples, wherein the message includes a known preamble, at least one start of message symbol and a payload, the method including:
(a) receiving (n−1) chip samples;
(b) determining whether k1 of the (n−1) received chip sample samples match the chip samples corresponding to one of the symbols of the preamble, where k1 is a first predetermined threshold such that 1<k1<(n−1), and if fewer than k1 received chip samples match the one of the symbols of the preamble, delaying by a time of p1 chip periods where p1 is a fraction of a chip period and repeating the method from step (a);
(c) receiving n chip samples per symbol and waiting for a symbol representing the start of the message;
(d) receiving n chip samples per symbol and receiving the message.

The invention proposes a search algorithm which quickly rejects false synchronisations.

Moreover, the logic used is designed to minimise the complexity of the method and hence the cost of implementation.

The value of p1 is chosen to check the complete range of possible start times in less than the time taken to transmit the preamble. This allows synchronisation even where the intitial timing chosen is very poor.

In a preferred arrangement p1=1/i where i is an integer. This keeps the algorithm as simple as possible.

In a preferred arrangement, step (c) includes (c1) receiving n chip samples;
(c2) determining whether k2 of the n received chip samples match the chip samples corresponding to one of the symbols of the preamble, where k2 is a second predetermined threshold greater than the first predetermined threshold, and if fewer than k2 received chip samples match a symbol of the preamble, repeating the method from step (a); and
(c3) repeating steps (c1) and (c2) until the n received chip samples do not match a symbol of the preamble sequence.

In this way, after the search algorithm of steps (a) and (b) have found a suitable timing to decode the received signal, the method waits for the end of the preamble. To avoid dropping a received message unnecessarily, k2 is preferably selected to avoid too great a chance of a good message being dropped. Thus, k2 may be quite low. In a preferred embodiment, k2 is less than k1.

After the preamble has been received, the method may continue by:
(c4) determining whether k3 of the n received chip samples match the chip samples corresponding to any of the symbols, where k3 is a third predetermined threshold greater than the first predetermined threshold, and if fewer than k3 received chip samples match the any symbol, repeating the method from step (a);
(c5) determining whether the symbol matched by the chip samples is part of the start of message symbol, and if not repeating the method from step (a).

The value of k3 may be selected so as to minimise the risk that noise will generate a false signal match whilst avoiding the risk that samples received in error will cause the message to be lost. Normally, k3 will be set higher than k2.

In a preferred arrangement, the method continues by:
(c6) receiving n chip samples;
(c7) determining whether k3 of the n received chip samples match the chip samples corresponding to one of the symbols of the start of message, and if fewer than k3 received chip samples match the chip samples corresponding to one of the symbols, repeating the method from step (a); and
(c8) repeating steps (c6) and (c7) until the complete start of message codeword has been received.

In a preferred arrangement, the invention tracks to correct for clock drift after the initial search phase of steps (a) and (b). Accordingly, in preferred embodiments step (c), step (d) or both, include:
(e) taking three sets of n chip samples, comprising an early set of n samples taken early in the chip period, a late set of n samples taken late in the chip period, and an expected set of n chip samples taken between the early and late samples; and
(f) comparing the early chip samples with the sets of chip samples representing symbols, comparing the expected chip samples with the sets of chip samples representing symbols, and comparing the late chip samples with the sets of chip samples representing symbols; and
(g) adjusting the chip timing based on the comparisons in step (f).

Taking the times of the early chip sample to be t1 from the start of the chip period, the time of the expected sample to be t2 and the time of the late sample to be t3, the times may be fixed at predetermined values after the end of the synchronisation period or alternatively varied.

Accordingly, the method may include changing t1 to be earlier on subsequent symbols until no more than k5 of the chips of the early sample match the symbol, wherein k5 is a predetermined value less than n; and changing t3 to be later on subsequent symbols until no more than k5 of the chips of the late sample match the symbol.

In a particularly preferred arrangement step (f) includes
(f1) determining whether more than k4 of the n early chip samples match one of the symbols, where k4 is a predetermined threshold 1<k4<n;
(f2) determining whether more than k4 of the n expected chip samples match one of the symbols; and
(f3) determining whether more than k4 of the n late chip samples match one of the symbols; and
step (g) includes:
(g1) delaying the timing of the next samples by a period being a fraction of the chip period if the k4 of the n expected chip samples match and k4 of the late chip samples match but k4 of the n early chip samples do not match; and
(g2) bringing forward the timing of the next samples by a period being a fraction of the chip period if the k4 of the n expected chip samples match and k4 of the early chip samples match but k4 of the n late chip samples do not match.

In embodiments, the method may include determining which of the n early, the n expected or the n late chip samples give the best match to the chip samples corresponding to one of the symbols; and delaying the timing of the next samples by a period being a fraction of the chip period if the late samples give the best match and bringing forward the timing of the next samples by a period being a fraction of the chip period if the early samples give the best match.

The method may also include a tracking algorithm during the initial search phase, and hence in embodiments step (a) includes taking three sets of (n−1) chip samples, comprising an early set of (n−1) samples taken early in the chip period, a late set of (n−1) samples taken late in the chip period, and an expected set of (n−1) chip samples taken between the early and late samples; step (b) includes determining whether k1 of the (n−1) received early, expected or late chip samples match a known symbol, where k1 is a first predetermined threshold such that 1<k1<(n−1), and if fewer than k1 received chip samples of any of the early, expected or late samples match the known preamble, delaying by a part p1 chip periods where p1 is a fraction of a chip period and repeating the method from step (a); and if k1 of the (n−1) received early, expected or late chip samples do match a known symbol, adjusting the timing so that the next sample is expected to give a good match to a symbol.

In another aspect, the invention relates to a method of receiving a direct sequence spread spectrum signal message including a plurality of symbols each represented by n chip samples each lasting a chip sample period, wherein each of a number of possible transmitted symbols is represented by a corresponding set of n chip samples, wherein the message includes a known preamble, at least one start of message symbol and a payload, the method including the steps of:
taking three sets of n chip samples, comprising an early set of n samples taken early in the chip period, a late set of n samples taken late in the chip period, and an expected set of n chip samples taken between the early and late samples; and
comparing the early chip samples with the sets of chip samples representing symbols, comparing the expected chip samples with the sets of chip samples representing symbols, and comparing the late chip samples with the sets of chip samples representing symbols;
adjusting the chip timing based on the comparisons; and
repeating the above steps for subsequent symbols using the adjusted timing.

The invention also relates to a computer program product arranged to control a direct sequence spread spectrum (DSSS) receiver to carry out the method as set out above.

In a further aspect, the invention relates to a direct sequence spread spectrum (DSSS) receiver, comprising:
a receiver for receiving a direct sequence spread spectrum signal message including a plurality of symbols each represented by n chip samples each lasting a chip sample period, wherein each of a number of possible transmitted symbols is represented by a corresponding set of n chip samples, wherein the message includes a known preamble, at least one start of message symbol and a payload;
a sampling unit for sampling the received signal message at controllable sampling times to provide a plurality of chip samples;
a data processor for processing the received chip samples and adjusting the sampling times; and
code arranged to cause the DSSS receiver:
(a) to receive (n−1) chip samples;
(b) to determine whether k1 of the (n−1) received chip samples match the chip samples corresponding to one of the symbols of the preamble, where k1 is a first predetermined threshold such that 1<k1<(n−1), and if fewer than k1 received chip sample samples match the one of the symbols of the preamble, delaying by a time of p1 chip periods where p1 is a fraction of a chip period and repeating the method from step (a);
(c) to receive n chip samples per symbol and waiting for a symbol representing the start of the message; and
(d) to receive n chip samples per symbol and receiving the message.

In a yet further aspect, the invention relates to a direct sequence spread spectrum (DSSS) receiver, comprising:
a receiver for receiving a direct sequence spread spectrum signal message including a plurality of symbols each represented by n chip samples lasting a chip sample period, wherein each of a number of possible transmitted symbols is represented by a corresponding set of n chip samples, wherein the message includes a known preamble, at least one start of message symbol and a payload;
a sampling unit for sampling the received signal message at controllable sampling times to provide a plurality of chip samples;
a data processor for processing the received chip samples and adjusting the sampling times; and
code arranged to cause the DSSS receiver:
to take three sets of n chip samples, comprising an early set of n samples taken early in the chip period, a late set of n samples taken late in the chip period, and an expected set of n chip samples taken between the early and late samples; and
to compare the early chip samples with the sets of chip samples representing symbols, comparing the expected chip samples with the sets of chip samples representing symbols, and comparing the late chip samples with the sets of chip samples representing symbols; and
to adjust the chip timing based on the comparisons; and
to repeat the above steps for subsequent symbols using the adjusted timing.

### BRIEF DESCRIPTION OF THE DRAWINGS

For a better understanding of the invention, embodiments will now be described with reference to the accompanying drawings, in which

FIG. 1 is a schematic diagram of a system according to the invention;

FIG. 2 is a schematic diagram of a message type used in the invention;

FIG. 3 is a flow diagram of a first embodiment of a method according to the invention;

FIG. 4 is a flow diagram of a second embodiment of a method according to the invention;

FIG. 5 is a flow diagram of a third embodiment of a method according to the invention;

FIG. 6 is a diagram of two chips of the signal used in the invention; and

FIG. 7 is a schematic diagram of an “eye”.

### DETAILED DESCRIPTION

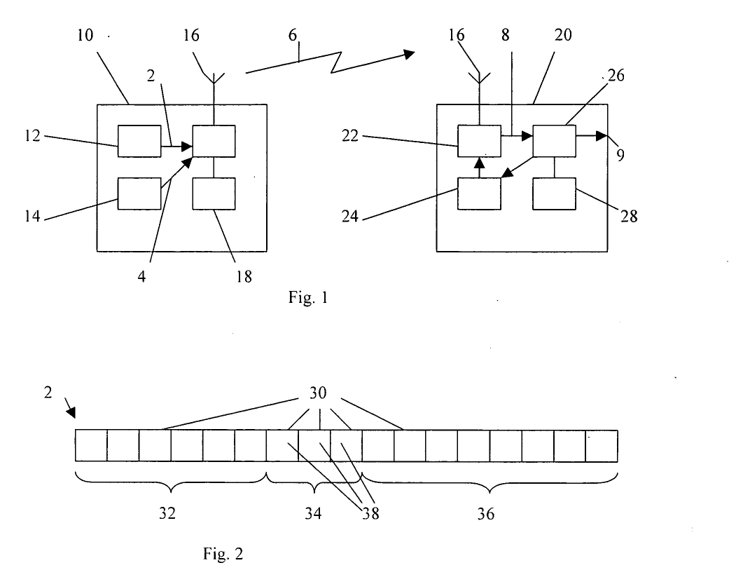

Referring to FIG. 1, a transmitter 10 combines a data signal 2 from data signal source 12 with a higher rate chipping code 4 from a pseudorandom code generator 14 and transmits the result as transmitted signal 6 on antenna 16. Each symbol in the data signal is thereby combined with n bits of the chipping code to provide a sequence of chips which represent that symbol. The period of a single chip will be referred to in this specification as the chip period. Clock 18 controls the transmission.

The transmitted signal 6 is received by receiver 20. The signal is sampled in sampling unit 22 under the control of timing control 24 including a local clock and passed to data processor 26. The data processor 26 synchronises the timing control and decodes the message as will be explained below. Data processor 26 cooperates with memory 28 to run processes, the processes being described in more detail below. Conveniently, the processes described below are recorded as program code in the memory in a manner that will be familiar to the skilled person. The skilled person will in particular be familiar with how to code for the specific steps of the methods set out below, when presented with those sets of steps.

The data signal 2 is illustrated in FIG. 2, and is made up of a number of symbols each lasting for a symbol period. The first part of the signal is the preamble 32 which is a regularly repeating pattern of symbols 30. Next, a start of message portion 34 contains one or more predetermined start of message symbols 38. Payload portion 36 containing a sequence of symbols.

As already mentioned, the transmitted signal consists of this data signal combined with the chipping code. Since each symbol is made up of n chips, the symbol period will be n times larger than the chip period.

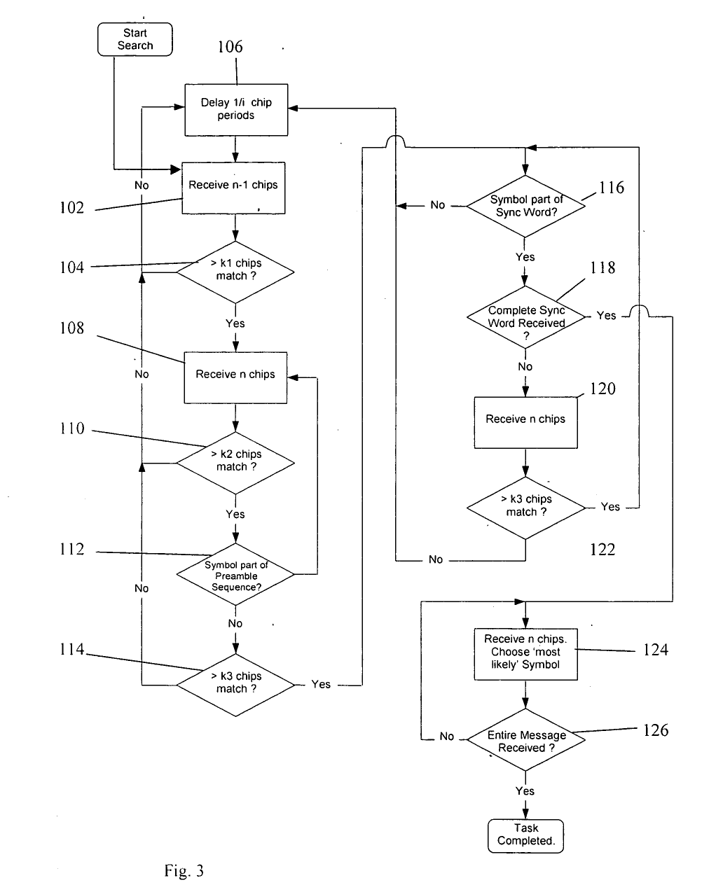

FIG. 3 illustrates a first method according to the invention for processing the received signal.

The initial phase uses a search algorithm.

First, n−1 chips are sampled 102. A test 104 is carried out to determine if more than a predetermined threshold k1 of those chips match a symbol of the expected preamble sequence. If no more than k1 samples match, this indicates that either there is no signal on the channel (noise) or (if there is a signal present) that the timing used would not achieve code synchronisation. A delay of 1/i (=p1) chip sample periods, where i is an integer, is introduced 106 and the search restarted.

In this way, the search will continuously sample the received signal until chip synchronisation is achieved. The value for i should be chosen such that the scan time is sufficiently fast, yet problems associated with sampling close to the chip sample transition boundaries are avoided.

By checking for a match only between the n−1 chips and symbols at symbol boundaries instead of trying all possible combinations of n−1 chips in all possible alignments the processing power is advantageously reduced.

If more than k1 samples match the expected spreading sequence then a second phase is entered. Chip sample synchronisation has been achieved and Code (byte) synchronisation is the next task to be performed.

The next phase is to wait until the start of message symbol(s) 34 arrives. Until this occurs, the preamble sequence 32 is received and discarded.

This is done by receiving (step 108) n chips and then testing (step 110) whether more than a second predetermined threshold k2 of the chips match the code for any of the possible symbols. If not, synchronisation has been lost and processing starts again from the beginning. The value of k2 should be selected so that the probability of noise appearing to match the preamble sequence is minimised while avoiding the risk that errors in a few chip samples cause a potentially good packet to be missed. In general, k2 is set lower than k1.

The received symbol is then tested (step 112) to see if it is a symbol of the preamble sequence 32 and if so processing returns to step 108 to wait for the end of the preamble.

If the symbol is not part of the preamble sequence 32 it is tested again (step 114) to see if more than a third predetermined threshold k3 of chips match the chipping sequence for a symbol. If not, synchronisation is lost and processing starts again at step 102. If the chips do indeed match a symbol, the symbol is then tested (step 116) to see if it matches part of the start of message 34. Failure causes processing to start again at step 102. The first time processing reaches step 116, the check is whether the first start of message symbol is received, and each subsequent time processing reaches step 116 the check is whether the chips match the next expected symbol.

The received symbol is then tested (step 118) to see if the complete start of message 34 has been received. If not, n further chips are received (step 120), it is tested whether ore than k3 of the chips match a possible symbol (step 122) and if so processing continues from step 1116. The value of k3 is selected so as to minimise the risk that noise will generate a false signal match whilst avoiding the risk that samples received in error will cause the message to be lost. Normally, k3 will be set higher than k2.

When all of the start of message has been received, the message payload 36 is received. For each symbol of the payload, n chips are received (step 124) and the most likely symbol determined. Processing repeats step 124 until the complete message is received.

By using this method, synchronisation can be rapidly achieved, yet the apparatus needed is not high cost since the method is relatively simple to implement. The synchronisation used is generally reliable, especially in the presence of noise.

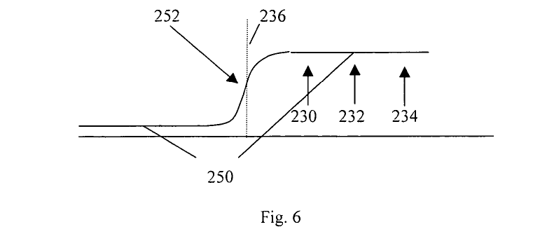

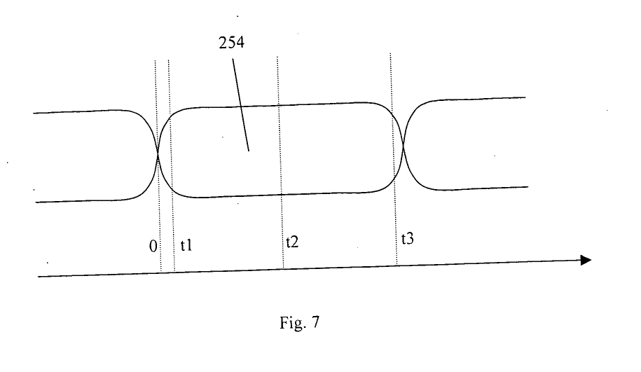

Referring to FIG. 6, as the chip signal changes from one chip 250 to another at the start of chip time 236 there is an intermediate period 252 during which the chip value may not be settled. The period between intermediate periods 252, i.e. the stable chip period, is known as the chip eye 254, shown in FIG. 7. In the version of the invention set out above with reference to FIG. 3, sampling at or close to the edge of the eye may cause the received sample error rate to increase. Even if the initial synchronisation is exactly right, such sampling close to the edge of the chip eye can easily occur as a result of clock drift.

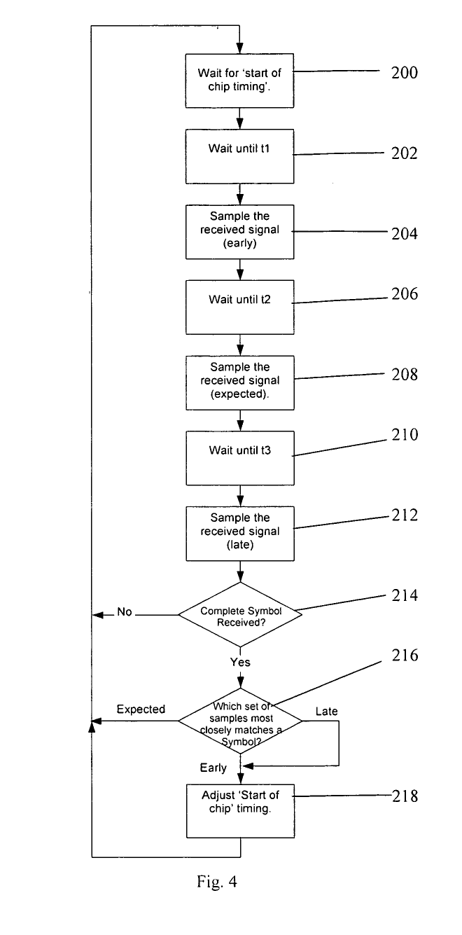

FIG. 4 shows a second embodiment of the method according to the invention which in addition to the functions carried out in the method described above carries out tracking during reception of a message to compensate for clock drift The initial search phase (i.e. steps 102, 104 and 106) is carried out as in the first embodiment and these steps will not be described again. After search is completed, instead of processing passing to step 108 processing passes to step 200 shown in FIG. 2.

Firstly, in step 200, the process waits for the expected start of a chip time. Then, the process waits step 202 for a fraction t1 of a chip period, where t1 is a fraction of a chip period (for example ⅙ of a chip period), and takes a first, early sample 230 in step 204. The process then waits 206 until a further time, at a fraction t2 of a chip period from the start of chip time (for example ½ of a chip period), and takes a second, expected sample 232 in step 208. The process waits 210 until a time t3, for example ⅚ of a chip period from the start of chip time, and takes 212 a third, late, sample 234. Thus, three samples are taken in a single chip period. t1, t2 and t3 are adjusted so that the expected sample is taken at the expected time for the optimum sample time, the early sample is taken a little earlier and the late sample a little later. The values suggested give an early sample ⅙ of the time into the expected chip period, the expected sample ½ of the time of an expected chip period and the late sample ⅚ of the time of the expected chip period. Thus, the samples are taken at equal time intervals which may in some circumstances be convenient, though it is not essential to the invention.

Steps 200 to 212 are then repeated until the n chips of a complete symbol is received (step 214). It is then tested 216 which of the set of early samples 230, the set of expected samples 232 and the set of late samples 234 most closely match one of the possible symbols. If the expected samples give the best fit, no adjustment is required. Otherwise, the start of chip time 236 is then adjusted accordingly in step 218. For example, if the early sample gives the best fit, the start of chip time 236 is adjusted to be slightly earlier for the next symbol of n chips. Conversely, if the late sample gives the best fit, the start of chip time 236 is adjusted to be slightly later.

In this way, the system can track slight drifts in the clock times.

The steps shown in FIG. 4 represent a tracking algorithm that can be used for any of the receive n chips steps 108, 120, 124 in the method of FIG. 3, and preferably for all of them. In a modification of this embodiment, steps 216 and 218 are replaced by a step of adjusting the start of chip time 236 using a measure of how well each of the early, expected and late chip samples match a symbol. In a preferred arrangement, this is done by selecting a threshold value k4 and determining whether the early, expected and late chip sample sets have more than k4 chips matching the sample that give the best fit. If all three chip sample sets fit, then no adjustment is made to chip timing. If on the other hand, the early and expected sample sets fit, but the late does not, the chip timing is adjusted to be a little earlier. Conversely, if the expected and late sample sets fit but the early sample set does not, the chip timing is adjusted to be a little later.

In a particularly preferred arrangement, the value of t1 and t3 may be set to put the early and late sample sets just within the central chip eye 254 during which the signal is expected to be stable enough to read. Then, the chip timing is adjusted not just by means of determining which of the early, expected and late set of chip samples give the best fit to a symbol, but by using all three values as described above. Since any clock drift will cause one of the early and late sample times to drift out of the chip eye 254, this may be quickly determined and compensated for.

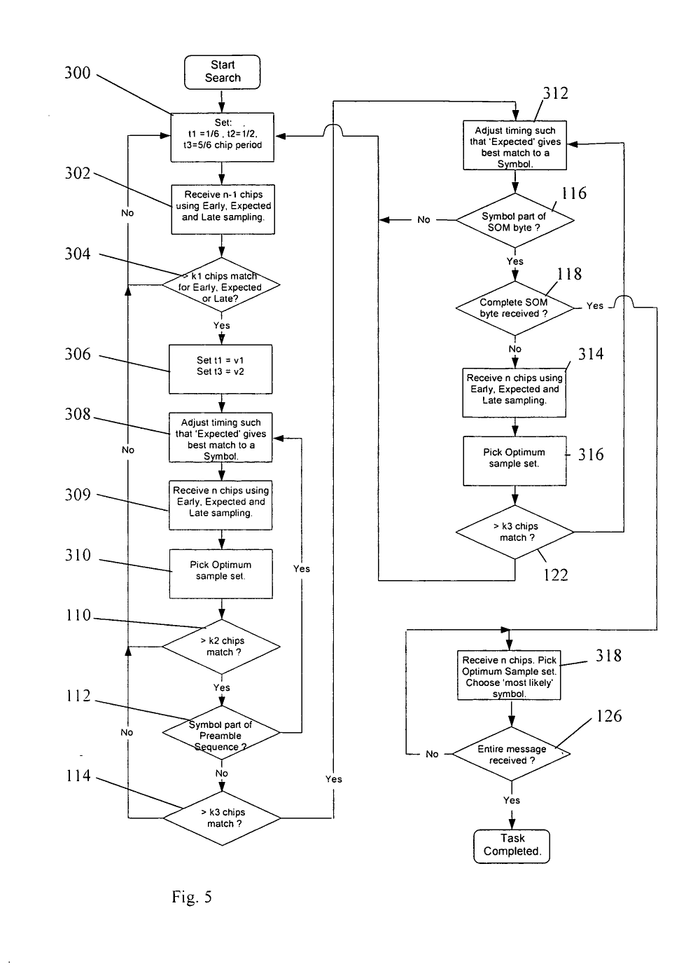

FIG. 5 shows a third embodiment of the invention, which combines both the search and tracking methods discussed above with reference to FIGS. 3 and 4, and differs from the second embodiment in that the tracking steps are used also in the initial search phase.

Initially, t1 is set to ⅙ chip periods, t2 to ½ a chip period and t3 to ⅚ chip periods. (step 300). In step 302, (n−1) chip samples are taken using early, expected and late sample times. Next, if more than k1 of the early, or of the expected, or of the late samples match, processing continues at test step 304, otherwise processing returns to step 300.

If processing continues, t1 and t3 are set to predetermined values v1 and v2 (step 306), t2 remaining at its initial value of ½. The start time is adjusted 308 so that the expected sample gives best match to a symbol. Then, processing proceeds largely as in the first embodiment, with the following modifications.

Instead of simply receiving n chip samples in step 108, n chips are sampled 309 using each of early, expected and late sample times and the best set selected (step 310). Then, if the preamble is over and k3 of these chips match a sample (step 114), the timing is adjusted (step 312) so that again the expected sample gives the best match for a symbol. Further, step 120 of the FIG. 1 method is replaced by steps 314 and 316 in which n chips are sampled 314 using early, expected and late sample times and then the optimum sample set is again selected 316. Likewise, step 124 is replaced by sampling n chips at early, expected and late times and choosing the most likely symbol.

The value of t1 and t3 may be variable and need not be fixed. In an embodiment, t1 and t3 take initial values which place the early 230, the expected 232 and the late 234 sample points equally apart. This may be used during the initial search phase.

Once synchronisation is achieved, the value of t1 and t2 are adjusted to be v1 and v2 to ensure that the expected sample 232 is taken at the expected time of the centre of the chip period 254. By careful selection of v1& v2 fine tuning of the optimum sample position may be accomplished.

In this embodiment, any differences in frequency between the transmitter clock and local clock in timing unit 24 will be compensated for as part of the tracking algorithm.

In a particular arrangement, after synchronisation is achieved, in step 306 t1 and t3 are set to initial values v1 and v2, for example ⅙ and ⅚ respectively, as before, though different values can be selected as before. Then, t1 is moved gradually earlier in the chip cycle until no more than k5 of the early chip samples match a symbol, and t3 is moved gradually later in the cycle until no more than k5 of the late chip samples match a symbol. In this way, t1 and t3 are arranged to be at the edge of the eye as shown in FIG. 7. The movement of t1 and t3 can occur on every subsequent symbol or t1 and t3 can be moved less often, either in a regular pattern or variably depending on the number of chips of the early, expected and late samples that match the symbol.

Such an approach ensures that the values of t1 and t3 eventually adopted are such that any slight drift in the timing quickly causes one of the early and late sample signals to leave the eye. In this way, the central sample can be maintained in the centre of the eye.

All of these approaches contribute to providing a means for reducing the amount of logic required, and thereby the cost, to implement the receive function.

In modifications of the invention, the sample points described above are replaced by multiple sample points which are averaged or otherwise processed to estimate the value at the sample times. For example, samples may be taken regularly and interpolation used to estimate the sample value at intermediate times.

The above embodiments are purely by way of example and the skilled person will readily be able to combine features of different embodiments and also features generally from the field of Spread Spectrum communications, and equivalents of the features mentioned above, without departing from the conception of the invention.

The inventors note that claims may be formulated to any combinations of the features herein described even if such features are not specifically described in combination.

1. A method of receiving a direct sequence spread spectrum signal message including a plurality of symbols each represented by n chip samples each lasting a chip sample period, wherein each of a number of possible transmitted symbols is represented by a corresponding set of n chip samples, wherein the message includes a known preamble, at least one start of message symbol and a payload, the method including:
(a) receiving (n−1) chip samples;
(b) determining whether k1 of the (n−1) received chip sample samples match the chip samples corresponding to one of the symbols of the preamble, where k1 is a first predetermined threshold such that 1<k1<(n−1), and if fewer than k1 received chip sample samples match the one of the symbols of the preamble, delaying by a time of p1 chip periods where p1 is a fraction of a chip period and repeating the method from step (a);
(c) receiving n chip samples per symbol and waiting for a symbol representing the start of the message;
(d) receiving n chip samples per symbol and receiving the message.

2. A method according to claim 1 wherein p1=1/i where i is an integer.

3. A method according to claim 1, wherein step (c) includes
(c1) receiving n chip sample samples;
(c2) determining whether k2 of the n received chip samples match the chip samples corresponding to one of the symbols of the preamble, where k2 is a second predetermined threshold greater than the first predetermined threshold, and if fewer than k2 received chip samples match a symbol of the preamble, repeating the method from step (a); and
(c3) repeating steps (c1) and (c2) until the n received chip samples do not match a symbol of the preamble sequence.

4. A method according to claim 3 wherein k2 is less than k1.

5. A method according to claim 2 wherein step (c) further comprises
(c4) determining whether k3 of the n received chip samples match the chip samples corresponding to any of the symbols, where k3 is a third predetermined threshold greater than the second predetermined threshold, and if fewer than k3 received chip samples match the any symbol, repeating the method from step (a);
(c5) determining whether the symbol matched by the chip samples is part of the start of message symbol, and if not repeating the method from step (a);

6. A method according to claim 5, wherein step (c) further comprises:
(c6) receiving n chip samples;
(c7) determining whether k3 of the n received chip samples match the chip samples corresponding to one of the symbols of the start of message, and if fewer than k3 received chip samples match the chip samples corresponding to one of the symbols, repeating the method from step (a); and
(c8) repeating steps (c6) and (c7) until the complete start of message codeword has been received.

7. A method according to claim 1 wherein step (d) includes L1
(d1) receiving n chip samples;
(d2) identifying the most likely symbol represented by the n chip samples; and
(d3) repeating steps (d1) and (d2) until the entire message is received.

8. A method according to claim 1, wherein
in step (c), step (d) or both, the step of receiving n chip samples includes:
(e) taking three sets of n chip samples, comprising an early set of n samples taken early in the chip period, a late set of n samples taken late in the chip period, and an expected set of n chip samples taken between the early and late samples; and
(f) comparing the early chip samples with the sets of chip samples representing symbols, comparing the expected chip samples with the sets of chip samples representing symbols, and comparing the late chip samples with the sets of chip samples representing symbols; and
(g) adjusting the chip timing based on the comparisons in step (f).

9. A method according to claim 8 wherein step (f) includes
(f1) determining whether more than k4 of the n early chip samples match one of the symbols, where k4 is a predetermined threshold 1<k4<n;
(f2) determining whether more than k4 of the n expected chip samples match one of the symbols; and
(f3) determining whether more than k4 of the n late chip samples match one of the symbols; and
step (g) includes:
(g1) delaying the timing of the next samples by a period being a fraction of the chip period if the k4 of the n expected chip samples match and k4 of the late chip samples match but k4 of the n early chip samples do not match; and
(g2) bringing forward the timing of the next samples by a period being a fraction of the chip period if the k4 of the n expected chip samples match and k4 of the early chip samples match but k4 of the n late chip samples do not match.

10. A method according to claim 8 wherein
step (f) includes determining which of the n early, the n expected or the n late chip samples give the best match to the chip samples corresponding to one of the symbols; and
step (g) includes delaying the timing of the next samples by a period being a fraction of the chip period if the late samples give the best match and bringing forward the timing of the next samples by a period being a fraction of the chip period if the early samples give the best match.

11. A method according to claim 8 wherein:
the early chip sample is taken at a time t1 from the start of the chip period, the expected sample at a time t2 from the start of the chip period and the late sample at a time t3 from the start of the chip period; the method comprising:
changing t1 to be earlier on subsequent symbols until no more than k5 of the chips of the early sample match the symbol, wherein k5 is a predetermined value less than n; and
changing t3 to be later on subsequent symbols until no more than k5 of the chips of the late sample match the symbol.

12. A method according to claim 1, wherein
step (a) includes taking three sets of (n−1) chip samples, comprising an early set of (n−1) samples taken early in the chip period, a late set of (n−1) samples taken late in the chip period, and an expected set of (n−1) chip samples taken between the early and late samples;
step (b) includes determining whether k1 of the (n−1) received early, expected or late chip samples match a known symbol, where k1 is a first predetermined threshold such that 1<k1<(n−1), and if fewer than k1 received chip samples of any of the early, expected or late samples match the known preamble, delaying by a part p1 chip periods where p1 is a fraction of a chip period and repeating the method from step (a); and
if k1 of the (n−1) received early, expected or late chip samples do match a known symbol, adjusting the timing so that the next sample is expected to give a good match to a symbol.

13. A method of receiving a direct sequence spread spectrum signal message including a plurality of symbols each represented by n chip samples lasting a chip sample period, wherein each of a number of possible transmitted symbols is represented by a corresponding set of n chip samples, wherein the message includes a known preamble, at least one start of message symbol and a payload, the method including the steps of:
taking three sets of n chip samples, comprising an early set of n samples taken early in the chip period, a late set of n samples taken late in the chip period, and an expected set of n chip samples taken between the early and late samples; and
comparing the early chip samples with the sets of chip samples representing symbols, comparing the expected chip samples with the sets of chip samples representing symbols, and comparing the late chip samples with the sets of chip samples representing symbols; and
adjusting the chip timing based on the comparisons; and
repeating the above steps for subsequent symbols using the adjusted timing.

14. A computer program product arranged to control a direct sequence spread spectrum (DSSS) receiver to receive a receive a direct sequence spread spectrum signal including a plurality of symbols each represented by n chip samples each lasting a chip sample period, wherein each of a number of possible transmitted symbols is represented by a corresponding set of n chip samples, wherein the message includes a known preamble, at least one start of message symbol and a payload, the computer program product including code:
(a) to receive (n−1) chip samples;
(b) to determine whether k1 of the (n−1) received chip sample samples match the chip samples corresponding to one of the symbols of the preamble, where k1 is a first predetermined threshold such that 1<k1<(n−1), and if fewer than k1 received chip sample samples match the one of the symbols of the preamble, to delay by a time of p1 chip periods where p1 is a fraction of a chip period and to repeat from (a);
(c) to receive n chip samples per symbol and to wait for a symbol representing the start of the message;
(d) to receive n chip samples per symbol and to receive the message.

15. A computer program product arranged to control a direct sequence spread spectrum (DSSS) receiver to receive a receive a direct sequence spread spectrum signal including a plurality of symbols each represented by n chip samples each lasting a chip sample period, wherein each of a number of possible transmitted symbols is represented by a corresponding set of n chip samples, wherein the message includes a known preamble, at least one start of message symbol and a payload, the computer program product including code:
to take three sets of n chip samples, comprising an early set of n samples taken early in the chip period, a late set of n samples taken late in the chip period, and an expected set of n chip samples taken between the early and late samples; and
to compare the early chip samples with the sets of chip samples representing symbols, to compare the expected chip samples with the sets of chip samples representing symbols, and to compare the late chip samples with the sets of chip samples representing symbols; and
to adjust the chip timing based on the comparisons; and
to repeat these steps for subsequent symbols using the adjusted timing.

16. A direct sequence spread spectrum (DSSS) receiver, comprising:
a receiver for receiving a direct sequence spread spectrum signal message including a plurality of symbols each represented by n chip samples lasting a chip sample period, wherein each of a number of possible transmitted symbols is represented by a corresponding set of n chip samples, wherein the message includes a known preamble, at least one start of message symbol and a payload;
a sampling unit for sampling the received signal message at controllable sampling times to provide a plurality of chip samples;
a data processor for processing the received chip samples and adjusting the sampling times; and
code arranged to cause the DSSS receiver to:
(a) to receive (n−1) chip samples;
(b) to determine whether k1 of the (n−1) received chip sample samples match the chip samples corresponding to one of the symbols of the preamble, where k1 is a first predetermined threshold such that 1<k1<(n−1), and if fewer than k1 received chip sample samples match the one of the symbols of the preamble, delaying by a time of p1 chip periods where p1 is a fraction of a chip period and repeating the method from step (a);
(c) to receive n chip samples per symbol and waiting for a symbol representing the start of the message; and
(d) to receive n chip samples per symbol and receiving the message.

17. A direct sequence spread spectrum (DSSS) receiver, comprising:
a receiver for receiving a direct sequence spread spectrum signal message including a plurality of symbols each represented by n chip samples lasting a chip sample period, wherein each of a number of possible transmitted symbols is represented by a corresponding set of n chip samples, wherein the message includes a known preamble, at least one start of message symbol and a payload;
a sampling unit for sampling the received signal message at controllable sampling times to provide a plurality of chip samples;
a data processor for processing the received chip samples and adjusting the sampling times; and
code arranged to cause the DSSS receiver:
to take three sets of n chip samples, comprising an early set of n samples taken early in the chip period, a late set of n samples taken late in the chip period, and an expected set of n chip samples taken between the early and late samples; and
to compare the early chip samples with the sets of chip samples representing symbols, comparing the expected chip samples with the sets of chip samples representing symbols, and comparing the late chip samples with the sets of chip samples representing symbols; and
to adjust the chip timing based on the comparisons; and
to repeat the above steps for subsequent symbols using the adjusted timing.
